(19) United States
(12) Patent Application Publication
(10) Pub. No.: US 2024/0129413 A1
(43) Pub. Date: Apr. 18, 2024

(54) MFP SYSTEM

(71) Applicant: SHARP KABUSHIKI KAISHA, Sakai City (JP)

(72) Inventor: Kazuhiro YOSHIMOTO, Sakai City (JP)

(21) Appl. No.: 18/380,089

(22) Filed: Oct. 13, 2023

(30) Foreign Application Priority Data
Oct. 14, 2022 (JP) 2022-165493

(51) Int. Cl. H04N 1/32; H04N 1/00

(52) U.S. Cl. CPC H04N 1/32064; H04N 1/00095; H04N 1/00347; H04N 1/32096; H04N 1/32363; H04N 2201/0094

(57) ABSTRACT

An MFP system includes a master device and a slave device. The slave device includes an operation acceptor, and an image reader, and is capable of communicating among a plurality of MFPs. The slave device includes an other-MFP transmission requester that makes a request to another MFP such that image data is transmitted by FAX transmission to a transmission destination. The master device includes an associator that, when an other-MFP transmission request is accepted from the slave device, associates and stores transmission destination information and the slave device, and when image data is received from the outside, the master device determines whether or not information of a transmission destination to which the image data was transmitted is stored in the associator, and if the information of the transmission destination is stored in the associator, transmits the image data received from the outside to the associated slave device.

### CROSS-REFERENCE TO RELATED APPLICATION

The present application claims priority from Japanese Application JP2022-165493, the content of which is hereby incorporated by reference into this application.

### BACKGROUND OF THE INVENTION

### 1. Field of the Invention

The present disclosure relates to an MFP system including a master device and a slave device.

### 2. Description of the Related Art

In the related art, disclosed is a device capable of facsimile transmission, being a digital cordless telephone provided with a slave device including a handset and a master device including a line connector, and having a wireless communication function between the master device and the slave device. According to the related art, disclosed is a facsimile device in which the slave device is provided with a printer that prints data from the master device, and a reader and compressor that reads a document and produces compressed data for a facsimile (hereinafter referred to as a “FAX”), and the master device is provided with a FAX modulator/demodulator. The facsimile device performs FAX transmission/reception by transmitting FAX data from the master device to the slave device and printing the FAX data when a FAX is received, and transmitting compressed data from the slave device to the master device when a FAX is transmitted.

### SUMMARY OF THE INVENTION

A conventional facsimile device provided with a slave device and a master device including a line connector has the configuration described above.

However, in the configuration described in the related art, although FAX transmission is possible when a master device FAX is used from the slave device, there is a problem that FAX reception is not possible from the slave device. Although this is not a problem when the master device and the slave device are installed close to each other, this can become a problem when they are provided away from each other, or are on different floors.

An aspect of the present disclosure has been made in order to solve the problem described above, and an object thereof is to provide an MFP system including a master device and a slave device in which FAX reception is also possible from the slave device.

An MFP system according to an aspect of the present disclosure includes a master device and a slave device, in which only the master device is connected to a FAX line. The slave device includes an operation acceptor that accepts an operation directed to the slave device, and an image reader that reads image data, and is capable of communicating among a plurality of MFPs, the slave device including an other-MFP transmission requester that makes a request to another MFP such that image data read by the image reader is transmitted by FAX transmission to a transmission destination that has been accepted by the operation acceptor. Further, the master device includes an associator that, when an other-MFP transmission request is accepted from the slave device, associates and stores transmission destination information included in the other-MFP transmission request and the slave device from which the other-MFP transmission request is accepted, and when image data is received from the outside, the master device determines whether or not information of a transmission destination that received the image data received from the outside is stored in the associator, and if the information of the transmission destination is stored in the associator, transmits the image data received from the outside to the associated slave device.

The slave device preferably sets, at the time of installation, the master device to which the slave device makes a FAX transmission request.

In an embodiment of the present disclosure, the master device, in a case where an other-MFP transmission request is accepted from the slave device, does not associate and store transmission destination information included in a transmission request and the slave device from which the other-MFP transmission request is accepted in the associator, if the transmission destination information included in the transmission request indicates a certain transmission destination.

In another embodiment of the present disclosure, a plurality of slave devices is connected to the master device, and the master device, when an other-MFP transmission request is accepted from the slave device, and transmission destination information included in a transmission request and a slave device other than the slave device from which the other-MFP transmission request is accepted are associated in the associator, cancels the association.

When the master device cancels an association, the transmission destination information that has been cancelled does not have to be subsequently stored in the associator.

The master device may be provided with a registerer, and when an other-MFP transmission request is accepted from the slave device, there is a case where transmission destination information included in the other-MFP transmission request and the slave device from which the other-MFP transmission request is accepted is not associated and stored in the associator, and in such a case, the master device may register, in the registerer, the transmission destination information included in the other-MFP transmission request that is not stored in the associator.

The slave device may be connected to a plurality of master devices that are connected to the slave device and are capable of performing FAX transmission, and the slave device, at the time of FAX transmission, may select a master device capable of performing FAX transmission.

In an MFP system including a master device and a slave device, in which only the master device is connected to a FAX line, the master device includes an associator that, when an other-MFP transmission request is accepted from the slave device, associates and stores transmission destination information included in the other-MFP transmission request and the slave device from which the other-MFP transmission request is accepted, and when image data is received from the outside, determines whether or not information of a transmission destination that received the image data is stored in the associator, and if the information of the transmission destination is stored in the associator, transmits the received image data to the associated slave device. Therefore, it is possible to provide an MFP system including a master device and a slave device in which FAX reception can also be performed with the slave device.

The above object, other objects, features, and advantages according to an aspect of the present disclosure will become more apparent from the detailed description of the embodiments described below with reference to the drawings.

### BRIEF DESCRIPTION OF THE DRAWINGS

FIG. 1 is a diagram showing a transmission path in an MFP system consisting of a master device and a slave device according to an embodiment of the present disclosure.

FIG. 2 is a diagram showing a reception path in an MFP system consisting of a master device and a slave device.

FIG. 3 is a diagram showing a transmission path in an MFP system consisting of a master device and slave devices according to a second embodiment of the present disclosure.

### DETAILED DESCRIPTION OF THE INVENTION

### First Embodiment

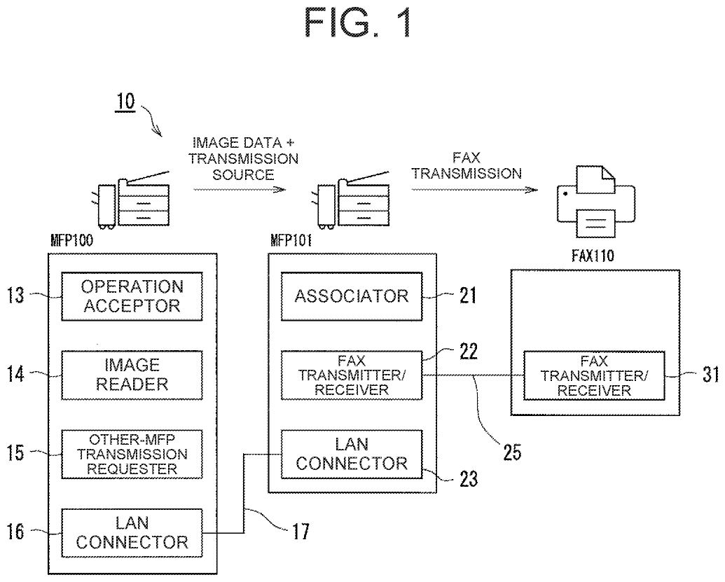

Hereinafter, an embodiment of the present disclosure will be described with reference to the drawings. FIG. 1 is a diagram showing a transmission path in an MFP (multifunctional peripheral) system consisting of a master device and a slave device according to a first embodiment of the present disclosure. Referring to FIG. 1, the MFP system 10 includes a slave device MFP 100, and a master device MFP 101 which is connected to the slave device MFP 100 by a LAN line 17. The master device MFP 101 includes an associator 21, a FAX transmitter/receiver 22, and a LAN connector 23, and is connected to a FAX 110, which is another MFP, by a FAX line 25 that is connected to the FAX transmitter/receiver 22.

The slave device MFP 100 includes an operation acceptor 13 that accepts an operation directed to the slave device MFP 100, an image reader 14 that reads an image, an other-MFP transmission requester 15 that requests transmission to another MFP, and a LAN connector 16.

The FAX 110, which is externally provided, includes a FAX transmitter/receiver 31, and is connected to the master device MFP 101 by the FAX line 25.

In the present embodiment, the slave device MFP 100 sets, at the time of installation, the master device MFP 101 as the MFP that performs FAX transmission, and performs FAX transmission to the external FAX 110 using the FAX transmitter/receiver 22 of the master device MFP 101. The user designates the destination of a FAX transmission using the operation acceptor 13 of the slave device MFP 100, and causes the image reader 14 to read document data (image data). The slave device MFP 100 transmits the designated FAX transmission destination information (FAX number/internet FAX address) and the document data to the master device MFP 101 via the LAN connector 16 and the LAN line 17. The master device MFP 101 automatically stores (registers) the FAX transmission destination information, which has been received from the slave device MFP 100, and the slave device MFP 100 in the associator 21, and then transmits the received document data to the FAX 110, which is the designated FAX transmission destination, via the FAX line 25.

Furthermore, at this time, the associator 21 registers the FAX number of the transmission destination, which represents a transfer source, and the slave device MFP 100, which is the transfer destination. In addition, by associating an email address, transfer to an email address is also possible.

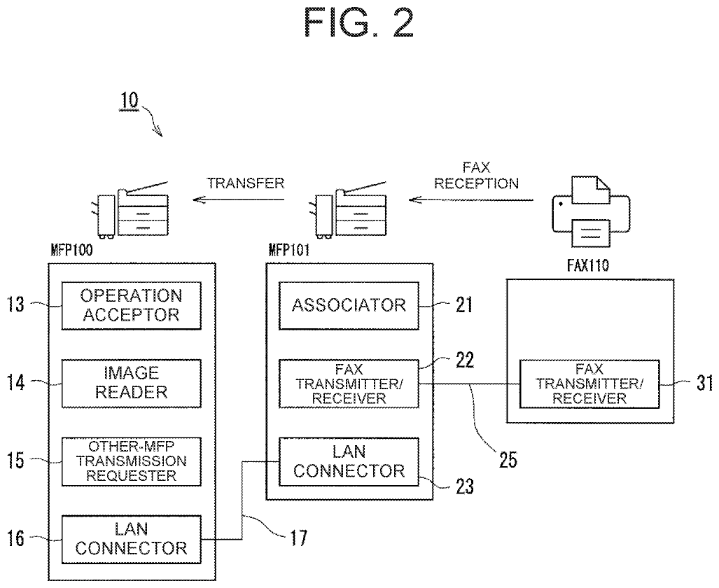

Next, a reception path will be described. FIG. 2 is a diagram showing a reception path in an MFP system consisting of a master device and a slave device. Referring to FIG. 2, when the master device MFP 101 performs FAX reception from the external FAX 110, it searches whether or not the FAX number (acquired from a number display or a TSI (transmitting subscriber identification)) or an internet FAX address of the FAX 110 is stored in the associator 21. If it is stored in the associator 21, the master MFP 101 transmits (by a data transfer or a print request) the received FAX image to the associated slave device MFP 100 using the LAN line 17.

### Second Embodiment

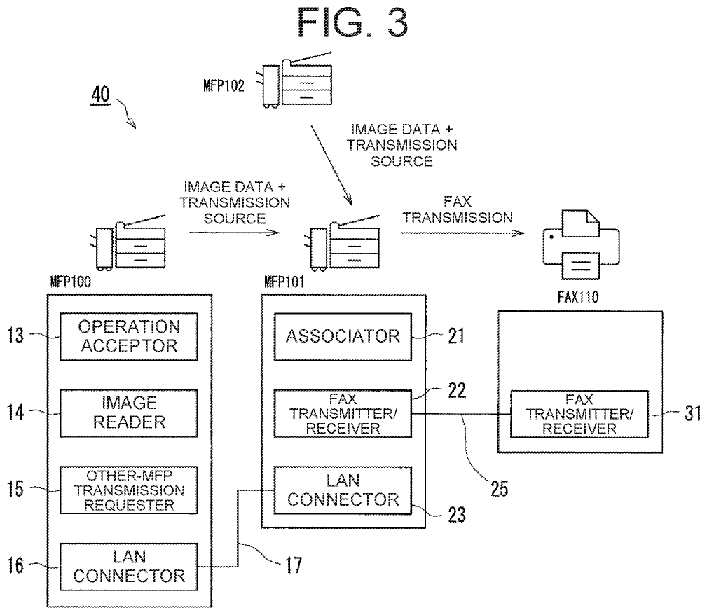

Next, a second embodiment of the present disclosure will be described. FIG. 3 is a diagram showing a transmission path in an MFP system consisting of a master device and a slave device according to a second embodiment of the present disclosure. Referring to FIG. 3, in the second embodiment, the MFP system 40 has two slave device MFPs 100 and 102 connected to a master device MFP 101.

Like the first embodiment, a problem does not exist when the only MFP that transmits to the FAX 110 is the slave device MFP 100. However, if the slave device MFP 102 also transmits to the FAX 110 via the master device MFP 101 in addition to the slave device MFP 100, it is difficult to determine whether the FAX transfer destination should be the slave device MFP 100 or the slave device MFP 102. Therefore, a designation is possible in which a specific FAX transmission destination (FAX number/internet FAX address) is excluded from being a slave device MFP that is registered in the associator 21, and is not associated. Specifically, this occurs in a case such as that described below.

For example, in a case where there is a department A and a department B, the slave device MFP 100 and the slave device MFP 102 are provided in the respective departments, and these are connected to a single master device MFP 101, the two slave device MFPs 100 and 102 may perform FAX transmission to the same transmission destination (such as the FAX 110). In this case, it may be unknown whether the destination of the FAX from the reply destination is the department A or the department B. Therefore, in such a case, a designation is possible in which a specific FAX transmission destination (FAX number/internet FAX address) is excluded from being a slave device MFP that is registered in the associator 21, and is not associated.

Note that, in such a case, the content of the FAX reply may be roughly checked by an OCR (character recognition device) or the like, such that the reply is sent to the slave device MFP of the relevant department.

Alternatively, in such a case, when a FAX transmission request is made by a first slave device MFP to another MFP (FAX), the information may be associated in the associator 21, and when a second FAX transmission request is made to the same FAX destination, the information may not be associated. Furthermore, this may be performed manually.

Further, printing may be performed by the master device MFP 101 without registration in the associator 21, and then a transmission may be made to the slave device MFP 100 or the slave device MFP 102 via the LAN line 17.

Moreover, if a plurality of slave device MFPs, such as the slave device MFPs 100 and 102, is connected to the master device MFP 101, when the master device MFP 101 accepts an other-MFP transmission request from the plurality of slave device MFPs, and the transmission destination information included in the transmission request and a slave device other than the slave device from which the other-MFP transmission request is accepted are associated in the associator 21, the master device MFP 101 may cancel the association.

In addition, in a case where the master device MFP 101 cancels an association, the transmission destination information that has been cancelled may not be subsequently stored in the associator 21.

Also, the master device MFP 101 may be provided with a registerer that is separate from the associator 21, and when an other-MFP transmission request is accepted from the slave device MFP, and the transmission destination information included in the other-MFP transmission request and the slave device from which the other-MFP transmission request is accepted are not associated and stored in the associator, the master device MFP 101 may register, in the registerer, the transmission destination information included in the other-MFP transmission request that is not stored in the associator 21.

Furthermore, instead of designating the FAX transmission destination using the operation acceptor 13 of the slave device MFP 100, the FAX transmission destination information may be embedded as image data in the FAX document (cover page). In this case, the FAX transmission destination may be designated by OCR from the read image data. Moreover, when the transmission destination information is embedded in the read image in the form of a QR code or the like, the transmission destination information may be restored from the QR code or the like and then used as the FAX transmission destination information.

Next, a modification of the second embodiment will be described. In the embodiment described above, two slave device MFPs 100 and 102 are connected to one master device MFP 101, and the master device MFP 101 is set as the actual FAX transmission destination.

However, in this modification, a plurality of slave device MFPs and a plurality of master device MFPs that are capable of FAX transmission are provided. In this case, each of the plurality of slave device MFPs automatically select a master device MFP that is capable of performing FAX transmission, and transmits a transmission destination and image data to the master device MFP. In this case, the master device MFP that performs FAX transmission is selected using the operation acceptor 13 of the slave device MFP 100 at the time of the actual transmission.

While there have been described what are at present considered to be certain embodiments of the invention, it will be understood that various modifications may be made thereto, and it is intended that the appended claims cover all such modifications as fall within the true spirit and scope of the invention.

### INDUSTRIAL APPLICABILITY

According to an aspect of the present disclosure, an MFP system can be provided that includes a master device and a slave device, in which FAX reception is also possible from the slave device. Therefore, it is effective as an MFP system including a master device and a slave device.

Furthermore, the functional blocks or various features of the device used in the embodiments described above may be implemented or executed as an electrical circuit, such an integrated circuit or a plurality of integrated circuits. An electrical circuit designed to execute the functions described herein may include a general-purpose processor, a digital signal processor (DSP), an application-specific integrated circuit (ASIC), a field programmable gate array (FPGA), or other programmable logic devices, discrete gates or transistor logic, discrete hardware components, or a combination of these. A general-purpose processor may be a microprocessor or a conventional processor, controller, microcontroller, or state machine. The electrical circuit described above may be configured by a digital circuit or an analog circuit. Moreover, when an integrated circuit technology that replaces the current integrated circuits emerges as a result of advances in semiconductor technology, one or more aspects of the present disclosure may also use the new integrated circuits based on such technology.

What is claimed is:

1. An MFP system comprising a master device and a slave device, in which only the master device is connected to a FAX line, wherein
the slave device includes an operation acceptor that accepts an operation directed to the slave device, and an image reader that reads image data, and is capable of communicating among a plurality of MFPs, the slave device including an other-MFP transmission requester that makes a request to another MFP such that image data read by the image reader is transmitted by FAX transmission to a transmission destination that has been accepted by the operation acceptor, and
the master device includes an associator that, when an other-MFP transmission request is accepted from the slave device, associates and stores transmission destination information included in the other-MFP transmission request and the slave device from which the other-MFP transmission request is accepted, and when image data is received from the outside, the master device determines whether or not information of a transmission destination to which the image data received from the outside was transmitted is stored in the associator, and if the information of the transmission destination is stored in the associator, transmits the image data received from the outside to the associated slave device.

2. The MFP system according to claim 1, wherein
the slave device sets, at the time of installation, the master device to which the slave device makes a FAX transmission request.

3. The MFP system according to claim 1, wherein
the master device, in a case where an other-MFP transmission request is accepted from one of the slave devices, does not associate and store, in the associator, transmission destination information included in the transmission request and the slave device from which the other-MFP transmission request is accepted, if the transmission destination information included in the transmission request indicates a certain transmission destination.

4. The MFP system according to claim 1, wherein
a plurality of the slave devices is connected to the master device, and
when an other-MFP transmission request is accepted from one of the slave devices, and transmission destination information included in the transmission request and a slave device other than the slave device from which the other-MFP transmission request is accepted are associated in the associator, the master device cancels the association.

5. The MFP system according to claim 4, wherein
when the master device cancels an association, the transmission destination information for which the association has been cancelled is subsequently not stored in the associator.

6. The MFP system according to claim 1, wherein
the master device is provided with a registerer, and in a case where, even when an other-MFP transmission request is accepted from the slave device, transmission destination information included in the other-MFP transmission request and the slave device from which the other-MFP transmission request is accepted are not associated and stored in the associator, the master device registers, in the registerer, the transmission destination information included in the other-MFP transmission request that is not stored in the associator.

7. The MFP system according to claim 1, wherein
the slave device is connected to a plurality of master devices that are connected to the slave device and are capable of performing FAX transmission, and
the slave device, at the time of FAX transmission, selects a master device capable of performing FAX transmission.
